(19) United States
(12) Patent Application Publication
(10) Pub. No.: US 2023/0257862 A1
(43) Pub. Date: Aug. 17, 2023

(54) ANNEALING METHOD OF STEEL

(71) Applicant: ArcelorMittal, Luxembourg (LU)

(72) Inventors: Ranbir Singh JAMWAL, Houston, TX (US); Hassan GHASSEMI-ARMAKI, Schererville, IN (US); Anirban CHAKRABORTY, Saint John, IN (US); Pavan CHALLA VENKATASURYA, Downers Grove, IL (US)

(21) Appl. No.: 17/922,423

(22) PCT Filed: Apr. 22, 2021
(86) PCT No.: PCT/IB2021/053333

§ 371 Date: Oct. 31, 2022

(30) Foreign Application Priority Data
May 7, 2020 (WO) PCT/IB2020/054322

(51) Int. Cl. C23C 2/06; C22C 38/02; C22C 38/04; C22C 38/06; C22C 38/12; C23C 2/40; C21D 1/26; C21D 9/52

(52) U.S. Cl. CPC C23C 2/06; C22C 38/02; C22C 38/04; C22C 38/06; C22C 38/12; C23C 2/40; C21D 1/26; C21D 9/52; C21D 2211/005

(57) ABSTRACT

The present invention relates to a manufacturing method of a steel strip, a steel strip with controlled decarburized depth, a spot welded joint and the use of said steel strip or said spot welded joint. This invention is particularly well suited for the automotive industry due to the improvement of the Liquid Metal Embrittlement (LME) resistance along with target mechanical properties.

The present invention relates to a manufacturing method of a steel strip, a spot welded joint and the use of said steel strip or said spot welded joint. This invention is particularly well suited for the automotive industry due to the improvement of the Liquid Metal Embrittlement (LME) resistance property of advanced high strength steels.

### BACKGROUND

In order to reduce a vehicle's weight, high strength steels are used in the automotive industry, in particular for structural parts. Such steel grades comprise alloying elements to greatly improve their mechanical properties.

During their manufacture, before coating, full hard steels undergo an annealing step which increases their strength-ductility balance. In this step, the steel is heated and maintained above its recrystallization temperature in a controlled atmosphere and then cooled to a galvanizing temperature for zinc coating on the steel surface by hot dip galvanizing method.

For example, a common practice is to heat the full hard steel from ambient temperature to a recrystallisation temperature (heating step) and then hold this temperature (soaking step). Both steps are performed in an atmosphere comprising for example 5% by volume of H₂ along with 95% N₂, having a dew point of −20° C. or higher. Then the steel is rapidly cooled to a desired temperature.

In the heating and soaking sections, above around 700° C., the dew point is controlled in such a way that the oxygen present in the high dew point atmosphere in the furnace diffuses into the steel sub-surface at a higher rate as compared to the diffusion of oxide forming steel alloying elements such as Manganese (Mn), Aluminum (Al), Silicon (Si) or Chromium (Cr) towards steel surface.

Presence of C along with other oxide forming steel alloying elements such as Mn, Si, Cr and Al lead to at least two types of reaction.

Firstly, as represented in FIG. 1, the oxygen reacts with the carbon and forms gases (images A and B), such as CO₂ and CO, leading to a depletion of carbon atoms in the steel subsurface and creating a decarburized layer 1 (images C and D). Carbon depletion is stronger closer to the surface 2. In addition to above, carbon atoms from the bulk 3 diffuses into the carbon depleted zone 1 (image E). All those phenomena take place at the same time (image F). If more carbon atoms leave the steel subsurface layer than carbon atoms diffuse into said layer, the steel subsurface layer will be decarburized and/or form carbon depleted areas as compared to bulk steel carbon level.

Secondly, as represented in FIG. 2, the oxygen reacts with the steel alloying elements, such as manganese (Mn), aluminium (Al), silicon (Si) and chromium (Cr), having a higher affinity towards oxygen than iron, leading to the formation of oxides mostly at the steel subsurface which are known as internal selective oxides, reported as 4, and very minor amount at the surface known as external selective oxides, reported as 5. These oxides, being for example elemental oxides such as MnO, SiO₂. In addition, it forms complex mixed oxides such as MnSiO₃, MnSiO₄. Those oxides can be present in the form of discontinuous nodules or a continuous layer in the grain boundaries in the steel subsurface. These internal oxides are mostly present along the grain boundaries and within the grain as well.

In a subsequent process step, these steels are usually coated by another metal or metallic alloy, such as a zinc-based coating, to improve their properties such as corrosion resistance, phosphatability, etc. The metallic coatings can be deposited by hot-dip method or electroplating method. The hot dip zinc-based coating also known as hot dip galvanizing usually contains around 0.1 to 0.4 in weight percent of aluminium. Said aluminium preferentially reacts with iron and forms an inhibition layer between the steel/coating interface. This inhibition layer is principally made of Fe and Al and forms Fe₂Al₅₋ₓZnₓ(0<x<1), an intermetallic compound. Said inhibition layer may contain some Zn atoms.

When use in the automotive industry, the zinc coated steel sheets are usually welded together by the Resistance Spot Welding (RSW) method. During this process, liquid zinc or liquid zinc alloy penetrates the steel subsurface area and causes Liquid Metal Embrittlement (LME) of steel. It leads to a decrease of the steel ductility and causes early failure.

### SUMMARY OF THE INVENTION

Concerning the decarburized layer, the thicker the decarburized layer, the better the resistance against LME. However, the decarburized layer deteriorates the mechanical properties of the steel. It is mainly due to formation of soft ferrite phase in the steel subsurface area. The decarburized layer thickness has to be controlled in such a way that it provides excellent LME resistance along with satisfying a target mechanical property. Overall, annealing atmosphere needs to be controlled in such a way that it produces an optimal depth of decarburized layer satisfying both excellent LME resistance as well as targeted mechanical properties. The purpose of this invention is to provide a solution solving the aforementioned problems.

The present invention provides a method for the manufacture of a coated steel sheet coated with a zinc-based or an aluminium-based coating, comprising:
A) The provision of a steel sheet having the following chemical composition, in weight percent: 0.01≤Al≤1.0%, 0.07≤C≤0.50%, 0.3≤Mn≤5.0%, V<0.2%, 0.01≤Si≤2.45%, 0.35≤Si+Al≤3.5, N≤0.01%, P<0.02%, S≤0.01% and optionally at least one of the following elements, in weight percent: B≤0.004%, Co≤0.1%, Cu≤0.5%, 0.001≤Cr≤1.00%, 0.001≤Mo≤0.5%, Nb≤0.1%, Ni≤1.0%, Ti≤0.1%, the remainder of the composition being made of iron and inevitable impurities resulting from the elaboration,
B) The annealing of said steel sheet comprising, in this order:
   i) a pre-heating step wherein said steel sheet is heated from room temperature to a temperature T₁ between 550° C. and Ac1+50° C.,
   ii) a heating step wherein said steel sheet is heated from a temperature T₁ to a recrystallisation temperature T₂ between 720° C. and 1000° C. in an atmosphere A1, comprising between 0.1 and 15% by volume of H₂ with the balance made up of an inert gas, H₂O, O₂ and unavoidable impurities, having a dew point DP₁ between −10° C. and +30° C.
   iii) a soaking step wherein said steel sheet is held at said recrystallisation temperature T₂ in an atmosphere A2, comprising between 0.1 and 15% by volume of H₂ with the balance made up of an inert gas, H₂O, O₂ and unavoidable impurities, having a dew point DP₂ between −30° C. and 0° C., said dew point DP₁ being higher than said dew point DP₂ and
   iv) a cooling step,
C) The coating of said steel sheet with a zinc-based or an aluminium based coating.

Other characteristics and advantages of the invention will become apparent from the following detailed description of the invention.

### BRIEF DESCRIPTION OF THE DRAWINGS

To illustrate the invention, various embodiment and trials of non-limiting example will be described, particularly with reference to the following figures:

FIG. 1 illustrate various reactions happening in an annealing furnace.

FIG. 2 illustrates the internal and external oxidation of the steel alloying elements.

FIG. 3 illustrates an embodiment of an annealing furnace and a hot-dip coating installation.

FIG. 4 illustrates a second embodiment of annealing furnace and a hot-dip coating installation.

FIG. 5 illustrates an embodiment of an annealing cycle according to the invention.

FIG. 6 illustrates a second embodiment of an annealing cycle according to the invention.

FIG. 7 exhibits a first embodiment of a claimed steel sheet with galvanized coating.

FIG. 8 exhibits a second embodiment of a claimed steel sheet with galvannealed coating.

FIG. 9 exhibits two SEM images showing the influence of the claimed process on the decarburized layer on first steel grade (experiment A1 and A2*).

FIG. 10 exhibits two SEM images showing the influence of the claimed process on the internal oxides, inhibition layer and galvanized coating on first steel grade [experiment A1 (left image) and experiment A2* (right image)].

FIG. 11 exhibits two SEM images showing the influence of the claimed process on the decarburized layer (left image) and on the internal oxides, inhibition layer and galvanized coating (right image) on a second steel grade (experiment B1*).

FIG. 12 exhibits two SEM images showing the influence of the claimed process on the decarburized layer (left image) and on the internal oxides and galvannealed coating (right image) on first steel grade (experiment A3*).

FIG. 13 exhibits a SEM image showing the influence of the claimed process on the decarburized layer (left image) and on the internal oxides and galvannealed coating (right image) on second steel grade (experiment B2*).

FIG. 14 illustrates resistance spot welding process in 3-layer stack-up condition, showing probable location of LME crack formation.

FIG. 15 illustrates an embodiment of the resistance spot welding tests.

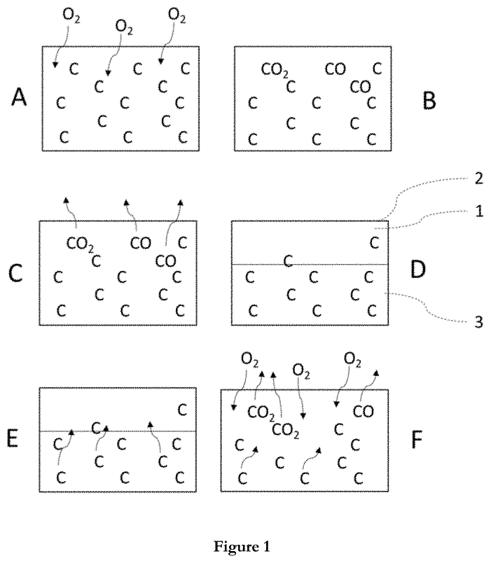

### DETAILED DESCRIPTION

The invention relates to a method for the manufacture of a coated steel sheet coated with a zinc-based or an aluminium-based coating, comprising:
A) The provision of a steel sheet having the following chemical composition, in weight percent:

0.01≤Al≤1.0%,

0.07≤C≤0.50%,

0.3≤Mn≤5.0%,

V<0.2%,

0.01≤Si≤2.45%,

0.35≤Si+Al≤3.5

N≤0.01%,

P<0.02%,

S≤0.01%
and optionally at least one of the following elements, in weight percent:

B≤0.004%,

Co≤0.1%,

0.001≤Cr≤1.00%,

Cu≤0.5%,

0.001≤Mo≤0.5%,

Nb≤0.1%,

Ni≤1.0%,

Ti≤0.1%,

the remainder of the composition being made of iron and inevitable impurities resulting from the elaboration,
B) The annealing of said steel sheet comprising, in this order:
   i) a pre-heating step wherein said steel sheet is heated from room temperature to a temperature T₁ between 550° C. and Ac1+50° C.,
   ii) a heating step wherein said steel sheet is heated from a temperature T₁ to a recrystallisation temperature T₂ between 720° C. and 1000° C. in an atmosphere A1, comprising between 0.1 and 15% by volume of H₂ with the balance made up of an inert gas, H₂O, O₂ and unavoidable impurities, having a dew point DP₁ between −10° C. and +30° C.,
   iii) a soaking step wherein said steel sheet is held at said recrystallisation temperature T₂ in an atmosphere A2, comprising between 0.1 and 15% by volume of H₂ with the balance made up of an inert gas, H₂O, O₂ and unavoidable impurities, having a dew point DP₂ between −30° C. and 0° C., said dew point DP₁ being higher than said dew point DP₂ and,
   iv) a cooling step,
C) The coating of said steel sheet with a zinc-based or an aluminium-based coating.

In the following paragraphs, the scope of the claimed invention will be discussed and explained.

The provisioned steel has the claimed composition for the following reasons:
0.01≤Al≤1.0% by weight Al increases Ms temperature and thus destabilises the retained austenite. In addition, with the increase of Al content above 1.0%, Ac3 temperature increases causing difficulty in industrial production.
0.07≤C≤0.50% by weight: if the carbon content is below 0.07%, there is a risk that the tensile strength is insufficient. Furthermore, if the steel microstructure contains retained austenite, its stability, which is necessary for achieving sufficient elongation, can be not obtained. If C content is more than 0.5%, hardenability of the weld increases.
0.3≤Mn≤5.0% by weight. Manganese is a solid solution hardening element which contributes to obtain high tensile strength. However, when the Mn content is above 5.0%, it can contribute to the formation of a structure with excessively marked segregated zones which can adversely affect the welds mechanical properties. Preferably, the manganese content is in the range between 1.5 and 3.0% by weight. This makes it possible to obtain satisfactory mechanical strength without increasing the difficulty of industrial fabrication of the steel and without increasing the hardenability in the welds.
V<0.2% by weight. Vanadium forms precipitates achieving hardening and strengthening.
0.01≤Si≤2.45% by weight. Si delays the carbide formation and stabilizes the austenite. When the Si content is more than 2.45%, then plasticity and toughness of the steel reduced significantly.

The steels may optionally contain elements such as Nb, B, Ni, Ti, Cu, Mo and/or Co for the following reasons.

Boron can optionally be contained in steel in quantity comprised below or equal to 0.004% by weight. By segregating at the grain boundary, B decreases the grain boundary energy and is thus beneficial for increasing the resistance to liquid metal embrittlement.

Chromium can be present with a content below or equal to 1.00% by weight. Chromium permits to delay the formation of pro-eutectoid ferrite during the cooling step after holding at the maximal temperature during the annealing cycle, making it possible to achieve higher strength level. Its content is limited to 1.00% by weight for cost reasons and to prevent excessive hardening.

Copper can be present with a content below or equal to 0.5% by weight for hardening the steel by precipitation of copper metal.

Molybdenum in quantity below or equal to 0.5% by weight is efficient for increasing the hardenability and stabilizing the retained austenite since this element delays the decomposition of austenite.

Nickel can optionally be contained in steel in quantity below or equal to 1.0% by weight so to improve the toughness.

Titanium and Niobium are also elements that may optionally be used to achieve hardening and strengthening by forming precipitates. However, when the Nb amount is above 0.1% and/or Ti content is greater than 0.1% by weight, there is a risk that an excessive precipitation may cause a reduction in toughness, which has to be avoided.

P and S are considered as a residual element resulting from the steelmaking. P can be present in an amount below or equal to 0.04% by weight. S can be present in an amount below or equal to 0.01% by weight.

Preferably, the chemical composition of the steel does not include Bismuth (Bi). Indeed, without willing to be bound by any theory, it is believed that if the steel sheet comprises Bi, the wettability decreases and therefore the coating adhesion.

For a proper understanding of the exposed invention, few terms will be defined. The dew point is the temperature to which air must be cooled to become saturated with water vapor. In the steelmaking, Ac1 corresponds to the temperature at which the Austenite start to form during heating. Ms corresponds to the temperature at which, upon rapid cooling, Austenite starts to form Martensite.

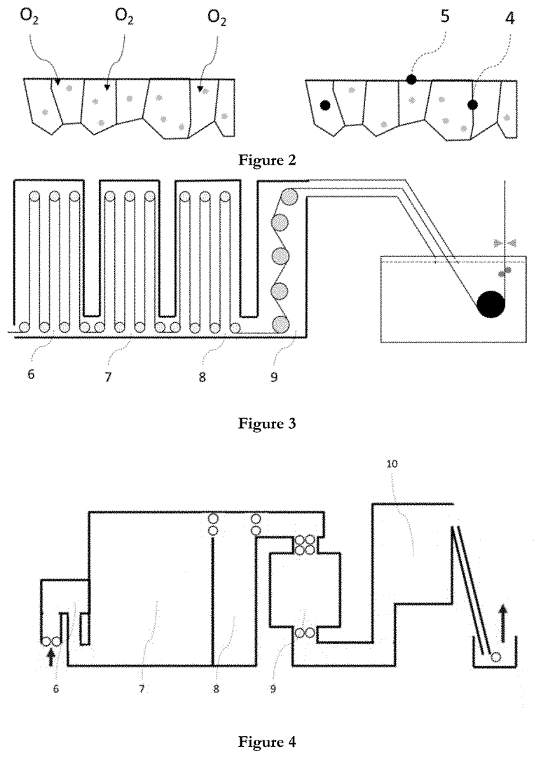

The several steps of the process can take place in furnaces as represented in FIG. 3 or in FIG. 4. Both furnaces comprise a pre-heating section 6, a heating section 7, a soaking section 8 and a cooling section 9. The furnace as illustrated in FIG. 4, also comprises a partitioning section 10.

The pre-heating step generally occurs after the steel has been cold-rolled also known as Full Hard condition. During this pre-heating, the steel sheet is heated from room temperature to a temperature T1 between 550° C. and Ac1+50° C. in a non-oxidizing atmosphere. It can be done in any heating means able to heat the steel at a temperature T1 without producing iron oxide or a in limited amount. For example, this step can be done in a RTF (Radiant Tube Furnace) having an atmosphere made up of N₂, H₂ and unavoidable impurities, in an heating by induction mean or in a DFF (Direct-Fired Furnace) having an atmosphere having an air/combustible gas ratio <1. However, it is possible in a DFF comprising several zones, e.g. 5 zones, to have a ratio air/combustible gas >1 in the last or the two last zones.

During the heating step, the steel sheet is heated from a temperature T₁ to a recrystallisation temperature T₂ between 720° C. and 1000° C. in an atmosphere A1, comprising between 0.1 and 15% by volume of H₂ with the balance made up of an inert gas, H₂O, O₂ and unavoidable impurities having a dew point DP₁ between −10° C. and +30° C. Nitrogen can be used as an inert gas.

During the soaking step, the steel sheet is heated at said recrystallisation temperature T₂ in an atmosphere A2, comprising between 0.1 and 15% by volume of H₂ with the balance made up of an inert gas, H₂O, O₂ and unavoidable impurities having a dew point DP₂ between −30° C. and 0° C., said dew points DP₁ being higher than said dew point DP₂. Nitrogen can be used as inert gas.

The atmospheres A1 and A2 can be achieved by using preheated steam and incorporating the N₂—H₂ gases in a furnace equipped with pyrometer, H₂ and dew point detectors in the different sections monitoring the H₂, atmosphere dew point and temperature.

The cooling can be achieved in an atmosphere comprising 20 to 50% of H₂ along with N₂. This gas mixture has been blown on the steel surface using a high-speed fan. The cooling can also be achieved by any other cooling means such as cooling rolls.

In the following part, without being bound by any theory, the physical phenomenon in the heating and soaking steps will be explained.

In the heating step, the gradual increase of temperature along with the comparatively high dew point permits to have a high pO₂ (partial pressure of oxygen) leading to the diffusion of the oxygen into the steel. This increased oxygen diffusion has two major consequences. Firstly, it permits deep decarburization of the steel sub-surface by the reaction with interstitial element carbon. Secondly, oxygen reacts with substitutional oxide forming elements such as Mn, Si, Al and Cr and forms internal oxide in the steel sub-surface area which reduces the amount of alloying element available to form surface oxides. Those internal oxides preferentially form on the grain boundary area due to a faster diffusion of these alloying elements.

At the end of the heating step, the steel sub-surface area comprises:
a partially decarburized layer having a thickness between 10 and 30 μm and a carbon weight-percent of between 5 and 20 percent of the carbon weight-percent of the bulk steel,
a decarburized layer, exterior to the partially decarburized layer, having a thickness between 30 and 70 μm and a carbon weight-percent of less than 5 percent of the carbon weight-percent of the bulk steel.

Those values are only given to get an order of magnitude. Parameters such as the heating time, temperature at the end of the heating, steel carbon content as well as the dew point which determines the pO₂ influence the thickness of said complete as well as partially decarburized layers.

In the soaking step, as compared to the heating step, the temperature is higher, but the dew point is lower. It has several effects on the steel sub-surface area.

Due to the comparatively lower dew point at the soaking section, the amount of oxygen is also lower and thus can only diffuse to a limited (smaller) depth into the steel sub-surface area causing a decarburization reaction in a limited depth of steel sub-surface area. In the meantime, carbon atoms diffuse from the bulk to the carbon depleted area of the steel sub-surface area (partially decarburized layer followed by decarburized layer). In fact, carbon atoms present in the partially decarburized area diffuse into the decarburised area and the partially decarburized area is back filled with the carbon atoms from the bulk. Thus, it produces a decarburized layer very close to steel surface. The said decarburization reaction depends on several factors such as the soaking temperature, the dew point (pO₂), the soaking duration and the amount of carbon present in the bulk steel.

Consequently, at the end of the soaking step, the steel sub-surface area comprises:
a partially decarburized layer having a thickness of around 30 μm and a carbon weight-percent of between 5 and 20 percent of the carbon weight-percent of the bulk steel.
a decarburized layer, exterior to the partially decarburized layer, having a thickness of around 20 μm and a carbon weight-percent of less than 5 percent of the carbon weight-percent of the bulk steel.

Those values are only given to get an order of magnitude.

Due to a higher partial pressure of oxygen (pO₂) in the heating section, higher amount of O₂ can easily diffuse in the steel sub-surface area and forms internal oxide and thus trap the Si, Mn, Cr, Al into much deeper in the sub-surface area. This phenomenon occurs in early stage of recrystallization in the heating section. In the soaking section, mostly grain growth and formation of large ferrite grains in the steel sub-surface area occur.

Due to the formation of internal oxides deeper into the steel sub-surface area followed by the grain growth, a ferrite layer free from internal oxides has been formed at the steel surface. This layer can easily react with the aluminium in the coating bath during galvanizing and forms a satisfying inhibition layer.

Contrary to the state of the art, in this annealing process, the dew point of the heating step is higher than of the soaking step permitting improvement of the steel properties in terms of liquid metal embrittlement (LME) resistance as previously explained. Apparently, the invention also has the advantage to produce a controlled depth of complete decarburized layer, having a carbon weight-percent of less than 5 percent of the carbon weight-percent of the bulk steel.

Preferably, the dew point DP₂ is between −25° C. and +10° C. Preferably, the dew point DP2 is between −20° C. and 0° C. Preferably, the dew point DP2 is between −25° C. and −5° C. Even more preferably, the dew point is between −25° C. and −5° C.

Preferably, said cooling step, said steel sheet is cooled down to a temperature T3 between Ms and Ms+150° C. and maintained at T3 for at least 40 seconds in an atmosphere A3 comprising between 1 and 30% by volume of H₂ and an inert gas, having a dew point DP3 below or equal to −40° C. Even more preferably, said temperature T3 is between Ms+10° C. and Ms+150° C. This permits to have a partitioned microstructure.

Preferably, after said cooling step iv), said steel sheet is further cooled down to a temperature T_{QT} between (Ms−5° C.) and (Ms−170° C.) and undergoes then a reheating step v) wherein said steel sheet is reheated up to a temperature T₄ between 300 and 550° C. during 30 s to 300 s. Such step is also known as a partitioning step. Even more preferably, said steel sheet is optionally held at T_{QT} for a duration comprised between 2 and 8 s. Even more preferably, said steel sheet is reheated up to a temperature T4 between 330 and 490° C.

Preferably, after said cooling step iv) and said reheating step v), an equalizing step vi) said steel strip is heated at a temperature between 300° C. and 500° C. in an atmosphere A4 comprising between 1 and 30% by volume of H₂ and at least an inert gas, having a dew point DP₄ below or equal to −40° C.

Preferably, said steel sheet in step A) has at least in weight percent: 0.001≤Cr+Mo≤1.000%.

Preferably, said heating and soaking steps last between 100 and 500 seconds. Preferably, in said heating and soaking steps, the atmosphere A1 and A2 comprise between 3 and 8% by volume of H₂.

Preferably, said DP₁ is between 5° C. and 40° C. higher than DP₂. Even more preferably, said DP₁ is between 10° C. and 30° C. higher than DP₂.

Preferably, in said step C) said coating is done by electroplating or hot-dip coating.

Preferably in said step C), said coating is done by hot-dip coating method and said steel strip is set at a temperature between 5° C. to 10° C. above a galvanizing bath, having an aluminium content between 0.15 and 0.40 weight percent, being maintained at a temperature between 450° C. to 470° C.

Preferably in said step C), said coating is done by hot-dip coating method and said steel strip is set at a temperature between 5° C. to 10° C. above a galvanizing bath, having an aluminium content between 0.09 and 0.15 weight percent, being maintained at a temperature between 450° C. to 470° C. and is then heated to a temperature between 470° C. and 550° C. after exiting said galvanizing bath. Such process steps permit production of a galvannealed steel strip.

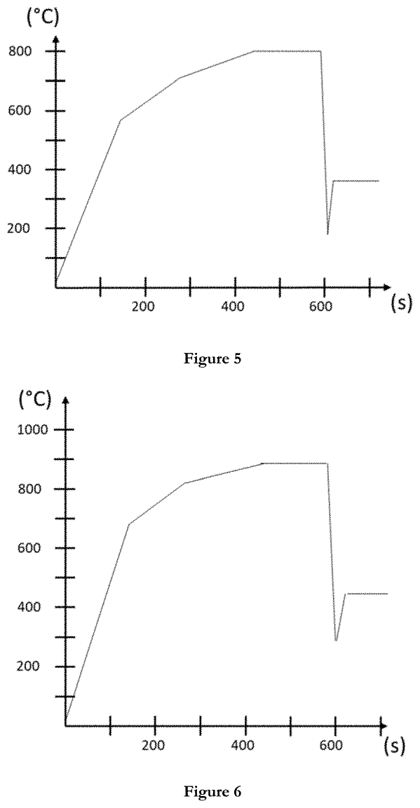

FIGS. 5 and 6 illustrate two typical thermal cycles described hereabove. On FIG. 5, the pre-heating of full hard steel sheet starts from room temperature and lasts 146 seconds until the steel reaches 575° C. Then during, the heating step, the steel is heated from 575° C. to 715° C. in 131 seconds and then from 715° C. to the soaking temperature (800° C.) in 174 seconds. Afterwards, a strip undergoes the soaking step where its temperature is maintained at 800° C. for 146 seconds. Finally, the strip is rapidly cooled down, by a quench, to a temperature of 190° C. After that, the sheet undergoes a re-heating stage also known as partition stage of heat treatment at 365° C. for 105 seconds and then cool down to 465° C. The steel is finally galvanized in a Zn-0.2 wt. % Al bath maintained at 460° C.

As shown in FIG. 6, the pre-heating of full hard steel sheet starts from room temperature and lasts 146 seconds until the steel reaches 675° C. Then during, the heating step, the steel is heated from 675° C. to 815° C. in 131 seconds and then from 815 to the soaking temperature (880° C.) in 174 seconds. Afterwards, the strip undergoes a soaking step where its temperature is maintained at 880° C. for soaking is carried out for 146 seconds. Finally, the strip is rapidly cooled down, by a quench, to a temperature of 280° C. After that, the sheet undergoes a re-heating stage also known as a partition stage of heat treatment at 450° C. for 105 seconds and then cools down to 460° C. The steel is finally galvanized in a Zn-0.2 wt. % Al bath maintained at 460° C.

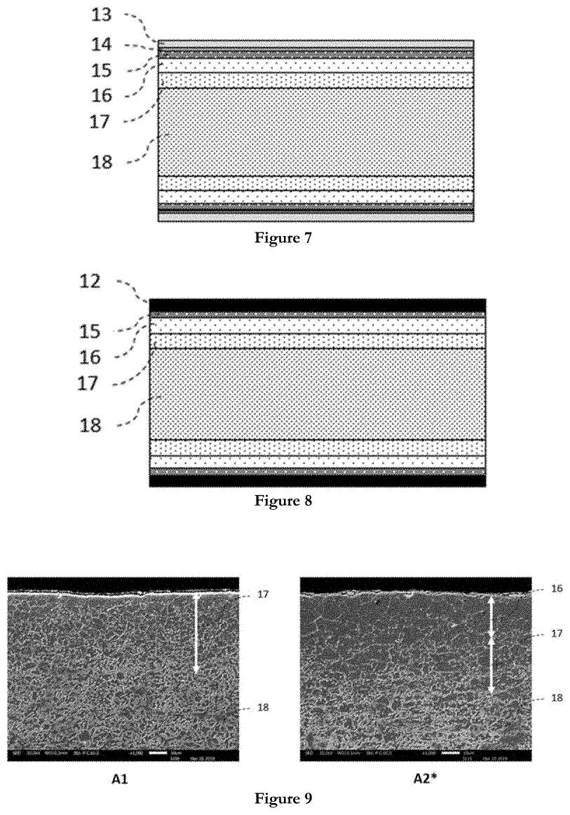

As illustrated in FIG. 7, the invention also relates to a galvanized steel strip, manufactured as previously described, comprising:
a steel bulk 18 having a composition as previously described,
a partially decarburised layer 17, on top of said steel bulk 18, having a thickness between 20 and 40 μm and a carbon weight-percent of between 5 and 20 percent of the carbon weight-percent of the bulk steel and having a microstructure comprising at least 50 percent of ferrite and at least one of the following constituents: bainite, martensite and/or retained austenite,
a decarburised layer 16 on top of said partially decarburised layer 17, having a thickness between 5 and 40 μm and a carbon weight-percent of less than 5 percent of the carbon weight-percent of the bulk steel and having a microstructure comprising at least 90 percent of ferrite, the upper part of said decarburized layer 16 comprising an internal oxide layer 15, having a thickness between 2 and 12 μm, and containing Mn, Si, Al and Cr based elemental oxides and mixed oxides of Mn, Si, Al and Cr,
an inhibition layer 14 on top of said internal oxide layer 15, having a thickness between 100 nm and 500 nm,
a zinc-based coating layer 13 on top of said inhibition layer 14 having a thickness between 3 and 30 μm.

Said internal oxide layer is on the exterior portion of the decarburised layer, closer to the inhibition layer as illustrated in FIG. 7. The internal oxide layer comprises the aforementioned oxides and has a carbon weight-percent of less than 5 percent of the carbon weight-percent of the bulk steel and has at least 90 percent of ferrite.

As illustrated in FIG. 8, the invention also relates to a galvannealed steel strip, manufactured as previously described, comprising:
a steel bulk 18 having a composition as previously described,
a partially decarburised layer 17 on top of said steel bulk 18 having a thickness between 20 and 40 μm and a carbon weight-percent of between 5 and 20 percent of the carbon weight-percent of the bulk steel and having a microstructure comprising at least 50 percent of ferrite and at least one of the following constituents: bainite, martensite and/or retained austenite,
a decarburised layer 16 exterior to the partially decarburised layer 17, having a thickness between 5 and 40 μm and a carbon weight-percent of less than 5 percent of the carbon weight-percent of the bulk steel and having a microstructure comprising at least 90 percent of ferrite, the upper part of said decarburized layer 16 comprising an internal oxide layer 15, having a thickness between 2 and 12 μm, and containing Mn, Si, Al and Cr based elemental oxides and mixed oxides of Mn, Si, Al and Cr,
an iron-zinc-based coating layer 12 on top of said internal oxide layer 15 having a thickness between 3 and 30 μm and containing between 10 and 20 weight percent of iron.

The internal oxide layer cannot be thicker than the decarburised layer. Consequently, if the decarburised layer has a thickness of “x” μm, x being between 5 and 12 μm, the internal oxide layer has a thickness between 2 and “x” μm. Said internal oxide layer is on the exterior portion of the decarburised layer, closer to the inhibition layer as illustrated in FIG. 8. The internal oxide layer comprises the aforementioned oxides and has a carbon weight-percent of less than 5 percent of the carbon weight-percent of the bulk steel and has at least 90 percent of ferrite.

Preferably, said steel strip has a thickness between 0.5 mm and 3.0 mm.

Preferably, said steel strip has an ultimate tensile strength (UTS) greater than 900 MPa.

The invention also relates to a spot welded joint of at least two metal sheets comprising at least a steel sheet as previously described, said joint containing zero crack having a size above 100 μm.

Preferably, said spot welded joint comprises two or three metal sheets. Preferably, said spot welded joint comprises also an aluminium sheet or a steel sheet.

The invention also relates to the use of any previously described coated steel sheet or of any previously described spot welded joint for the manufacture of automotive vehicle.

### EXPERIMENTAL RESULTS

The following section deals with experimental results exhibiting the improved surface and subsurface properties. The experiments have been performed on two different grades of steel (Steel A and Steel B) having a strip thickness between 1.4 to 1.6 mm.

The different experimental parameters are reported in Table 1.

A first set of experiments (A1 and A2*) was conducted to show the influence of the dew points difference in the heating and soaking sections on the decarburization behaviour of the steel, on a first steel grade (Steel A). The steel was annealed followed by galvanized in a Zn-0.20 wt. % Al coating bath as per the thermal cycles reported in FIG. 5 so the thermal cycles for both experiments are similar. In Experiment A1, almost similar dew points were maintained in the heat (−5° C.) and soaking sections (−3° C.). Whereas in the Experiment A2* a higher dew point was applied in the heating section (−1° C.) compared to the soaking section (−9° C.). For both experiments a hydrogen concentration between 4 and 5% was maintained in both sections.

A second experiment (A3*) was conducted on Steel A. The steel was annealed followed by a galvanized in a Zn-0.129 wt. % Al coating bath as per the thermal cycles reported in FIG. 5. Just after the galvanizing, post coating heat treatment also known as galvannealing was carried out at 480° C. In this experiment a higher dew point was also applied in the heating section (0° C.) as compared to the soaking section (−10° C.) and around 5% hydrogen was maintained in both sections.

A third experiment (BP) was carried out on a different steel grade (Steel B). The steel was annealed followed by a galvanized in a Zn-0.20 wt. % Al coating bath as per the thermal cycles reported in FIG. 6. The peak annealing temperature is higher in Steel B as compared to Steel A. In this experiment a higher dew point was also applied in the heating section (−5° C.) as compared to the soaking section (−20° C.) and around 5% hydrogen was maintained in both sections.

A fourth experiment (B2*) was also conducted on Steel B. The steel was annealed followed by a galvanized in a Zn-0.129 wt. % Al coating bath as per the thermal cycles reported in FIG. 6. Just after the galvanizing, post coating heat treatment also known as galvannealing was carried out at 510° C. In this experiment a higher dew point was also applied in the heating section (+4° C.) as compared to the soaking section (−5° C.) and around 5% hydrogen was maintained in both sections.

Experiments A2*, A3*, B1* and B2* are according to the present invention wherein the dew point of the heating section is higher than of the soaking section.

TABLE 1
Different experimental parameters

| Experiment | A1 | A2* | A3* | B1* | B2* |
|---|---|---|---|---|---|
| Steel composition | Steel A: | | | Steel B : | |
| (in weight percent) | C: 0.24, Mn: 2.02, Si: 1.02, | | | C: 0.23, Mn: 2.10, | |
| | Al: 0.44, Cr: 0.18, Nb: 0.031, | | | Si: 1.08, Al: 0.47, | |
| | V: 0.001, N: 0.003, P: 0.007, | | | Mo: 0.30, Nb: 0.02, | |
| | S: 0.002 | | | V: 0.001, N: 0.003, | |
| | | | | P: 0.007, S: 0.002 | |
| Strip thickness | 1.4 | 1.5 | 1.4 | 1.6 | 1.6 |
| (mm) | | | | | |
| T1 (° C.) | 575 | 575 | 575 | 675 | 675 |
| DP1 (° C.) | −5 | −1 | 0 | −5 | +4 |
| Heating H₂ | 4 | 4 | 4 | 5 | 5 |
| concentration (%) | | | | | |
| T2 (° C.) | 800 | 800 | 800 | 880 | 880 |
| DP2 (° C.) | −3 | −9 | −10 | −20 | −5 |
| Soaking H₂ | 5 | 4 | 5 | 5 | 5 |
| concentration (%) | | | | | |
| Cooling (Quench) | 190 | 190 | 190 | 280 | 280 |
| temperature (° C.) | | | | | |
| Temperature of the | 365 | 365 | 365 | 450 | 450 |
| re-heating after | | | | | |
| quenching | | | | | |
| (partitioning) (° C.) | | | | | |
| Duration of the | 105 | 105 | 105 | 105 | 105 |
| partitioning (sec) | | | | | |
| Coating bath | Zn-0.20 | Zn-0.20 | Zn-0.129 | Zn-0.20 | Zn-0.129 |
| composition | wt % Al | wt % Al | wt % Al | wt% Al | wt % Al |
| Coating Type | Galvan- | Galvan- | Galvan- | Galvan- | Galvan- |
| | ized | ized | nealed | ized | nealed |
| Galvannealing | — | — | 480 | — | 510 |
| Temperature (° C.) | | | | | |

*According to present invention

### Decarburized Layer

FIG. 9 compares the SEM micrographs of the decarburized layer formed in the steel sub-surface area of steel produced according to the experiment A1 (left picture) and A2* (right picture) using Steel A.

The micrograph A2* of the steel subsurface area as per the present invention presents:
steel bulk 18,
a partially decarburized layer 17 of around 30 μm having a carbon weight-percent of between 5 and 20 percent of the carbon weight-percent of the bulk steel,
a decarburized layer 16 of around 20 μm, having a carbon weight-percent of less than 5 percent of the carbon weight-percent of the bulk steel.

On the contrary, the micrograph A1 of the steel subsurface, as per the state of the art, shows only a steel bulk 18 and a partially decarburized layer 17 of around 45 μm. This comparison exhibits the benefits of the claimed method on the formation of a decarburized layer in the steel sub-surface area which is favourable in order to obtain the target mechanical as well as Liquid Metal Embrittlement resistance properties.

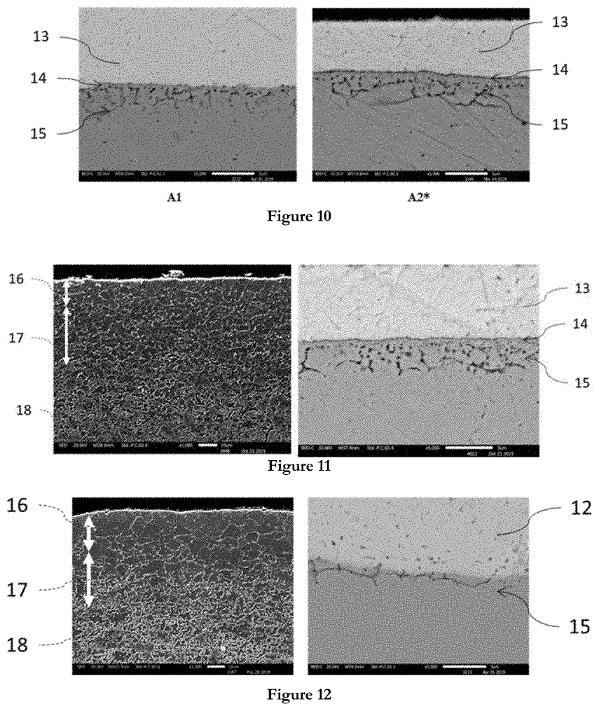

FIG. 10 shows the SEM micrographs of samples of Steel A produced through experiment A1 (left picture) and A2* (right picture) exhibiting the presence of internal oxides 15, inhibition layer 14 and galvanized coating 13.

FIG. 11 shows two SEM micrographs of a sample of Steel B produced through experiment B1*. The micrograph of the steel sub-surface presents:
a steel bulk 18,
a partially decarburized layer 17 of around 30 μm having a carbon weight-percent of between 5 and 20 percent of the carbon weight-percent of the bulk steel,
a decarburized layer 16 of around 15 μm, having a carbon weight-percent of less than 5 percent of the carbon weight-percent of the bulk steel,
the inhibition layer 14, the internal oxide layer 15 and the galvanized coating layer 13.

FIG. 12 shows two SEM micrographs of a sample of Steel A produced through experiment A3*. The micrograph on the left of the steel sub-surface presents:
steel bulk 18,
a partially decarburized layer 17 of around 30 μm having a carbon weight-percent of between 5 and 20 percent of the carbon weight-percent of the bulk steel,
a decarburized layer 16 of around 20 μm, having a carbon weight-percent of less than 5 percent of the carbon weight-percent of the bulk steel.

This experiment exhibits a preferable claimed method wherein DP₁ is between 5° C. and 30° C. higher than DP₂

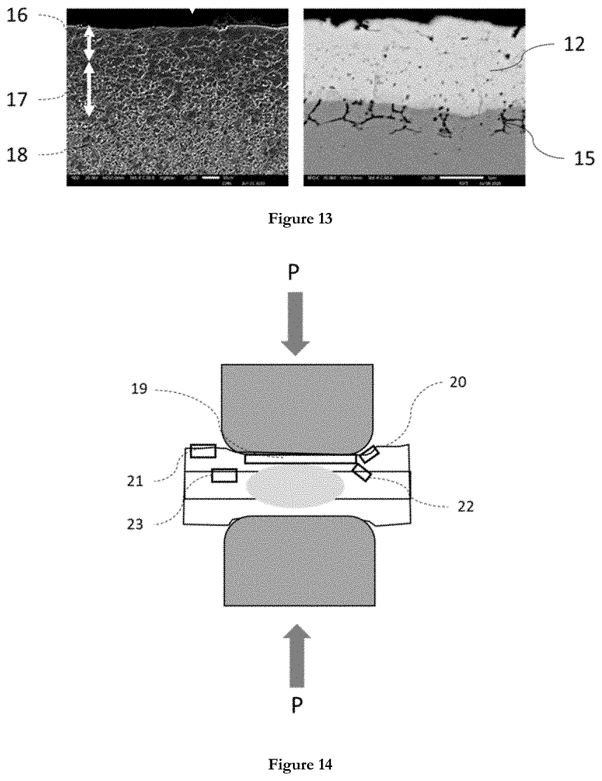

FIG. 13 shows two SEM micrographs of a sample of Steel B produced through experiment B2*. The micrograph on the left of the steel sub-surface presents:
a steel bulk 18,
a partially decarburized layer 17 of around 30 μm having a carbon weight-percent of between 5 and 20 percent of the carbon weight-percent of the bulk steel,
a decarburized layer 16 of around 15 μm, having a carbon weight-percent of less than 5 percent of the carbon weight-percent of the bulk steel,

### Galvanized and Galvannealed Coating

As shown in FIGS. 9 and 10 for experiment A2* and FIG. 11 for experiment B1*, claimed method produce suitable surface for reactive wetting during galvanizing. As reported in Table 1, during galvanizing of Steel A and Steel B, Zn-0.20 wt. % Al bath composition was maintained. During galvanizing continuous inhibition layer formed at steel/coating interface which indicate good reactive wetting behaviour.

In experiments A3* and B2*, galvannealed coated Steel A and Steel B respectively were produced after galvanizing in Zn-0.129 wt. % Al bath followed by post coating heat treatment (also known as galvannealing treatment) at 480° C. for Steel A and 510° C. for Steel B. FIG. 12 and FIG. 13 exhibit the cross-sectional SEM micrographs galvannealed coated Steel A and Steel B respectively. These micrographs show that the claimed method is suitable for the production of galvannealed coated steel.

### Evaluation of Resistance of Liquid Metal Embrittlement

The Liquid Metal Embrittlement (LME) susceptibility of above galvanized and galvannealed coated steel produced as per the thermal cycles reported in Table 1 were evaluated by resistance spot welding method on a steel produced in the condition of the A2*, A3*, B1* and B2* experiments. The type of the electrode was ISO Type B with a face diameter of 6 mm; the force of the electrode was 5 kN and the flow rate of water of was 1.5 g·min⁻¹. The welding cycle has been reported in Table 2:

TABLE 2
Welding schedule, to determine LME resistance property.

| Weld time | Current Level | Hold time |
|---|---|---|
| (mili-seconds) | (kilo-Amp) | (mili-seconds) |
| 380 | Iₘₐₓ | 300 |
| 380 | Iₘₐₓ + 10% Iₘₐₓ | 300 |

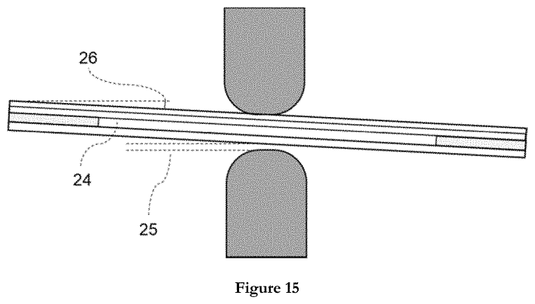

The LME crack resistance behaviour was evaluated using 3-layer stack-up condition. In this condition, three coated steel sheets were welded together by resistance spot welding as shown in FIG. 14 exhibiting an indentation area 19, an area deformed due to the indentation 20, a heat affected zone (HAZ) area 21, a HAZ/Weld nugget interfacial area 22 and faying surfaces in the HAZ area 23. All the resistance spot welding tests were carried out including severe noise factors such as Gap 24 between two sheet steel, Offset 25 between welding electrode and said steel sheet and Electrode Angle 26 between welding electrode and said sheet steel which are schematically represented in FIG. 15. The number of cracks above 100 μm was then evaluated using an optical microscope as reported in Table 3 in all 5 locations as illustrated in FIG. 14. Excellent LME resistance behaviour was observed in steel sheet in wide range sheet thickness with as well as without welding noise factors due to presence of specific thickness of decarburized layer.

TABLE 3
LME crack details after resistance
spot welding (3-layer stack-up conditions)

| | | | Number | Number |
|---|---|---|---|---|
| | | | of LME | of LME |
| | | | cracks having | cracks having |
| | | Steel | moret han | more than |
| | | sheet | 100 μm crack | 100 μm crack |
| | | thick- | length at | length at |
| Experi- | Noise | ness | Welding | Welding Current |
| ment | Factors | (mm) | Current (Iₘₐₓ) | (Iₘₐₓ + 10% Iₘₐₓ) |
| A2* | Nil | 0.9, 1.6 and | 0 | 0 |
| | | 2 mm | | |
| | 2 mm Gap, | 0.9, 1.6 and | 0 | 0 |
| | 2 mm Offset | 2 mm | | |
| | and 3° C. | | | |
| | electrode angle | | | |
| A.3* | Nil | 1.4 | 0 | 0 |
| | 2 mm Gap, | 1.4 | 0 | 0 |
| | 2 mm Offset | | | |
| | and 3° C. | | | |
| | electrode angle | | | |
| B1* | Nil | 1.6 | 0 | 0 |
| | 2 mm Gap, | 1.6 | 0 | 0 |
| | 2 mm Offset | | | |
| | and 3° C. | | | |
| | electrode angle | | | |
| B2* | Nil | 1.6 | 0 | 0 |
| | 2 mm Gap, | 1.6 | 0 | 0 |
| | 2 mm Offset | | | |
| | and 3° C. | | | |
| | electrode angle | | | |

What is claimed is:

1-15. (canceled)

16. A method for manufacture of a coated steel sheet coated with a zinc-based or an aluminium-based coating, the method comprising:
A) providing a steel sheet having the following chemical composition, in weight percent: 0.01≤Al≤1.0%, 0.07≤C≤0.50%, 0.3≤Mn≤5.0%, V<0.2%, 0.01≤Si≤2.45%, 0.35≤Si+Al≤3.5, N≤0.01%, P<0.02%, S≤0.01% and optionally at least one of the following elements, in weight percent: B≤0.004%, Co≤0.1%, Cu≤0.5%, 0.001≤Cr≤1.00%, 0.001≤Mo≤0.5%, Nb≤0.1%, Ni≤1.0%, Ti≤0.1%, a remainder of the composition being made of iron and inevitable impurities resulting from processing;
B) annealing the steel sheet with the following steps in order:
i) a pre-heating step wherein the steel sheet is heated from room temperature to a temperature T₁ between 550° C. and Ac1+50° C.,
ii) a heating step wherein the steel sheet is heated from a temperature T₁ to a recrystallisation temperature T₂ between 720° C. and 1000° C. in an atmosphere A1, comprising between 0.1 and 15% by volume of H₂ with the balance made up of an inert gas, H₂O, O₂ and unavoidable impurities, having a dew point DP₁ between −10° C. and +30° C.
iii) a soaking step wherein the steel sheet is held at the recrystallisation temperature T₂ in an atmosphere A2, comprising between 0.1 and 15% by volume of H₂ with the balance made up of an inert gas, H₂O, O₂ and unavoidable impurities, having a dew point DP₂ between −30° C. and 0° C., the dew point DP₁ being higher than the dew point DP₂ and
iv) a cooling step; and
C) coating the steel sheet with a zinc-based or an aluminium based coating.

17. The method as recited in claim 16 wherein in the cooling step, the steel sheet is cooled down to a temperature T3 between Ms and Ms+150° C. and maintained at T3 for at least 40 seconds in an atmosphere A3 including between 1 and 30% by volume of H₂ and an inert gas, having a dew point DP₃ below or equal to −40° C.

18. The method as recited in claim 17 wherein after the cooling step, the steel sheet is further cooled down to a temperature T_{QT} between (Ms−5° C.) and (Ms−170° C.) and undergoes then a reheating step v) wherein the steel sheet is reheated up to a temperature T₄ between 300 and 550° C. for 30 s to 300 s.

19. The method as recited in claim 18 wherein the steel sheet is held at T_{QT} during 2 to 8 s.

20. The method as recited in claim 18 further comprising, after said cooling step iv) and said reheating step v), an equalizing step vi) wherein the steel strip is heated up to a temperature between 300° C. and 500° C. in an atmosphere A4 including between 1 and 30% by volume of H₂ and at least an inert gas, having a dew point DP₄ below or equal to −40° C.

21. The method as recited in claim 16 wherein DP₁ is between 5° C. and 40° C. higher than DP₂.

22. The method as recited in claim 21 wherein DP₁ is between 10° C. and 30° C. higher than DP₂.

23. The method as recited in claim 16 wherein in the step C), the coating is performed by hot-dip coating and the steel strip is set at a temperature between 5° C. to 10° C. above a galvanizing bath, having an aluminium content between 0.15 and 0.40 weight percent, being maintained at a temperature between 450° C. to 470° C.

24. The method as recited in claim 16 wherein in the step C), the coating is performed by hot-dip coating and the steel strip is set at a temperature between 5° C. to 10° C. above a galvanizing bath, having an aluminium content between 0.09 and 0.15 weight percent, being maintained at a temperature between 450° C. to 470° C. and the steel strip is then heated to a temperature between 470° C. and 550° C. after exiting said galvanizing bath.

25. A galvanized steel strip, manufactured according to the method as recited in claim 16, and comprising:
a steel bulk having the chemical composition;
a partially decarburised layer on top of the steel bulk and having a thickness between 20 and 40 μm and a carbon weight-percent between 5 and 20 percent of the carbon weight-percent of the bulk steel and having a microstructure including at least 50 percent of ferrite and at least one of the following constituents from the group consisting of bainite, martensite and retained austenite;
a decarburised layer on top of the partially decarburised layer and having a thickness between 5 and 40 μm and a carbon weight-percent of less than 5 percent of the carbon weight-percent of the bulk steel and having a microstructure including at least 90 percent of ferrite, the upper part of the decarburized layer including an internal oxide layer having a thickness between 2 and 12 μm, and containing Mn, Si, Al and Cr based elemental oxides and mixed oxides of Mn, Si, Al and Cr;
an inhibition layer on top of the internal oxide layer and having a thickness between 100 nm and 500 nm; and
a zinc-based coating layer on top of the inhibition layer having a thickness between 3 and 30 μm.

26. A galvannealed steel strip, manufactured according to the method as recited in claim 24, comprising:
a steel bulk having the chemical composition;
a partially decarburised layer on top of the steel bulk and having a thickness between 20 and 40 μm and a carbon weight-percent between 5 and 20 percent of the carbon weight-percent of the bulk steel and having a microstructure including at least 50 percent of ferrite and at least one of the following constituents from the group consisting of bainite, martensite and retained austenite;
a decarburised layer on top of the partially decarburised layer and having a thickness between 5 and 40 μm and a carbon weight-percent of less than 5 percent of the carbon weight-percent of the bulk steel and having a microstructure including at least 90 percent of ferrite, the upper part of the decarburized layer including an internal oxide layer having a thickness between 2 and 12 μm, and containing Mn, Si, Al and Cr based elemental oxides and mixed oxides of Mn, Si, Al and Cr; and
an iron-zinc-based coating layer on top of the internal oxide layer and having a thickness between 3 and 30 μm and containing between 10 and 20 weight percent of iron.

27. The steel strip as recited in claim 26 wherein the steel strip has a thickness between 0.5 mm and 3.0 mm.

28. The steel strip as recited in claim 27 wherein said steel strip has an ultimate tensile strength greater than 900 MPa.

29. The steel strip as recited in claim 25 wherein the steel strip has a thickness between 0.5 mm and 3.0 mm.

30. The steel strip as recited in claim 29 wherein said steel strip has an ultimate tensile strength greater than 900 MPa.

31. A spot welded joint of at least two metal sheets including at least the steel strip as recited in claim 25, the joint containing zero crack having a size above 100 μm.

32. A spot welded joint of at least two metal sheets including at least the steel strip as recited in claim 26, the joint containing zero crack having a size above 100 μm.

33. A method of employing the steel strip as recited in claim 25 in the manufacture of an automotive vehicle.

34. A method of employing the steel strip as recited in claim 26 in the manufacture of an automotive vehicle.
